(19) United States
(12) Patent Application Publication
(10) Pub. No.: US 2010/0151902 A1
(43) Pub. Date: Jun. 17, 2010

(54) Method and Apparatus for Rotating a First and/or Second Portion of an Electronic Device

(75) Inventors: Nigel Richardson, Surrey (GB); Mark C. Potter, Hampshire (GB)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/335,511

(22) Filed: Dec. 15, 2008

(51) Int. Cl. H04M 1/00

(52) U.S. Cl. 455/556.1; 455/575.1; 455/566

(57) ABSTRACT

In accordance with an example embodiment of the present invention, an apparatus comprises a first portion comprising a user interface. Further, the apparatus comprises a second portion comprising an input device. The apparatus comprises a rotatable mechanism configured to rotatably move the first portion and the second portion over a pivot axis to align the first portion and a second portion in a horizontal or vertical position.

### TECHNICAL FIELD

The present application relates generally to rotating a first and/or second portion of an electronic device into a horizontal or vertical position.

### BACKGROUND

A user may use an electronic device to use applications. Further, the electronic device may provide different types of applications. As such, the electronic device facilitates use different types of applications.

### SUMMARY

Various aspects of examples of the invention are set out in the claims.

According to a first aspect of the present invention, an apparatus comprises a first portion comprising a user interface. Further, the apparatus comprises a second portion comprising an input device. The apparatus comprises a rotatable mechanism configured to rotatably move the first portion and the second portion over a pivot axis to align the first portion and a second portion in a horizontal or vertical position.

According to a second aspect of the present invention, a method comprises rotatably moving a first portion and a second portion over a pivot axis to align the first portion and second portion in a horizontal or vertical position.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram of an electronic device operating in accordance with an example embodiment of the invention;

FIG. 3 is an exploded view of the electronic device of FIG. 2 operating in accordance with an example embodiment of the invention;

FIGS. 4A-C are diagrams depicting the rotating of an electronic device in accordance with an example embodiment of the invention; and

FIGS. 5A-D are diagrams depicting rotatably aligned electronic devices in accordance with an example embodiment of the invention.

### DETAILED DESCRIPTION OF THE DRAWINGS

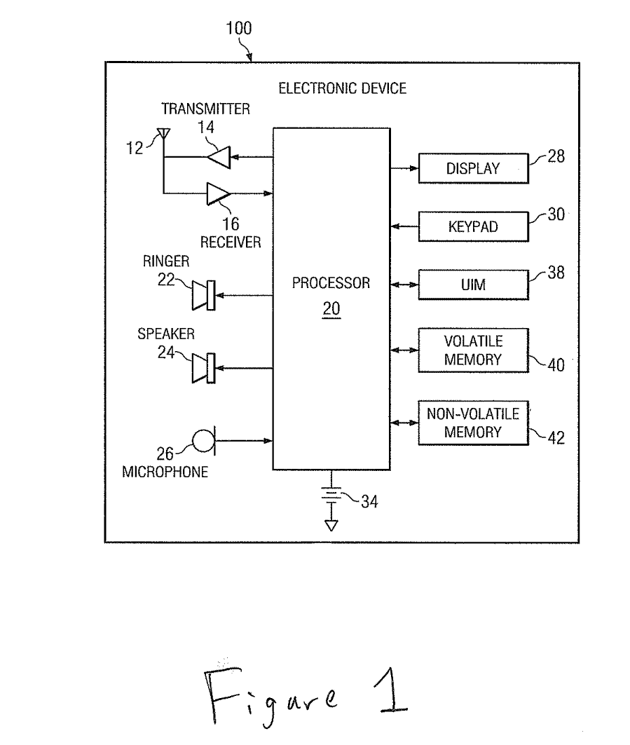

An example embodiment of the present invention and its potential advantages are best understood by referring to FIGS. 1 through 5D of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

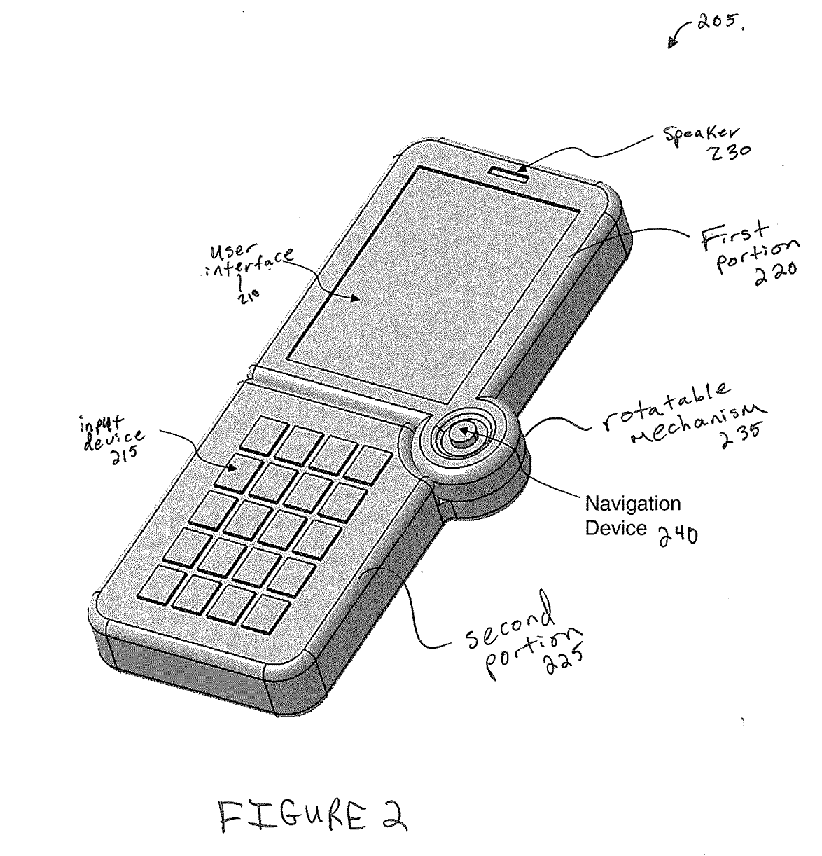

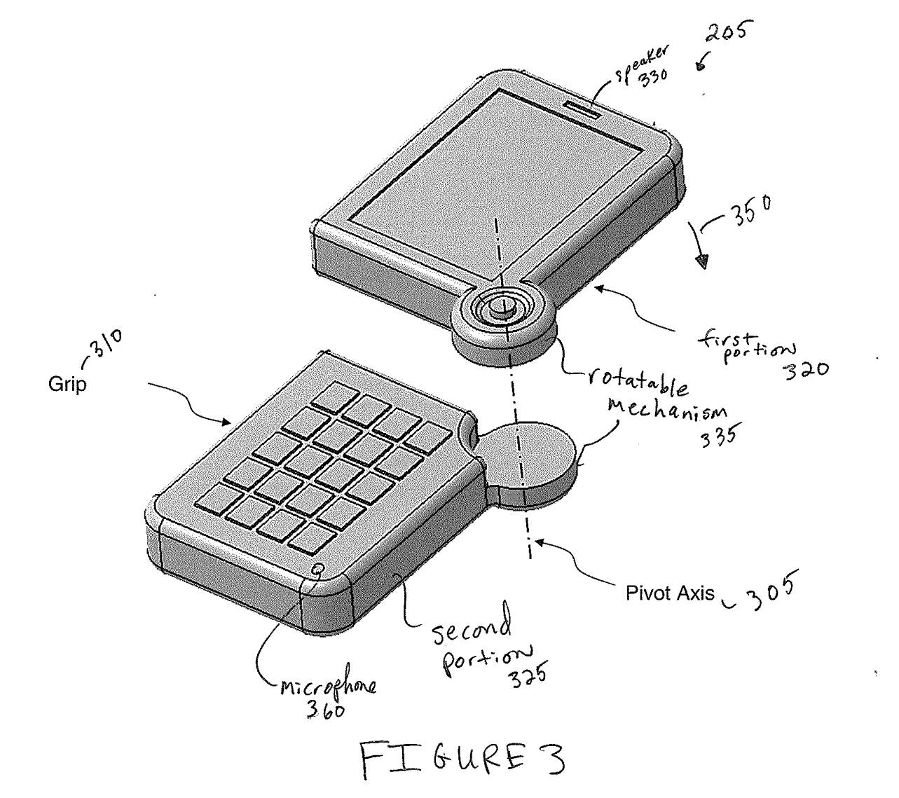

FIG. 2 is a block diagram of an electronic device 205 operating in accordance with an example embodiment of the invention. In an example embodiment, the electronic device 205 comprises a user interface 210, an input device 215, a first portion 220, a second portion 225, a speaker 230, and/or a rotatable mechanism 235. In an embodiment, the rotatable mechanism 235 comprises a navigation device 240. In an example embodiment, the electronic device 205 is similar to electronic device 100 of FIG. 1. In an alternative embodiment, the electronic device 205 is different than electronic device 100 of FIG. 1.

In an example embodiment, the first portion 220 is formed of a one or more materials, such as plastics, metal, wood, glass, stone, natural fibers, synthetic fibers, and/or the like. In an embodiment, the first portion 220 comprises a user interface 210, a speaker 230, and/or the like. In an embodiment, the user interface 210 is a display. Further, the first portion 220 may be configured to reduce friction during use of the rotatable mechanism 235 based at least in part on materials.

In an embodiment, the second portion 225 comprises an input device 215, a joystick, a grip, and/or the like. In an example embodiment, the second portion 225 is formed of a one or more materials, such as plastics, metal, wood, glass, stone, natural fibers, synthetic fibers, and/or the like. Further, the second portion 225 may be configured to reduce friction during use of the rotatable mechanism 235 based at least in part on the materials.

In an example embodiment, the first portion 220 and the second portion 225 are different sizes. In an alternative embodiment, the first portion 220 and the second portion 225 are substantially the same size.

In an embodiment, the second portion 225 comprises an input device 215. In an embodiment, the input device 215 allows the electronic device 205 to receive or transmit data. For example, the input device 215 comprises any of a number of devices configured to receive data, such as a keypad, a touch display, other input device, and/or the like. In an embodiment, the keypad comprises the conventional numeric, e.g., 0-9, and/or related keys, e.g., #, *, other hard and/or soft keys, and/or the like to operate the electronic device 205. In an alternative embodiment, the keypad comprises a conventional QWERTY keypad arrangement. In yet another alternative embodiment, the keypad comprises a half or hybrid QWERY keypad arrangement. Further, the keypad comprises various soft keys with associated features.

In an example embodiment, the rotatable mechanism 235 is configured to rotatably move the first portion 220 and/or the second portion 225 to align the first portion 220, second portion 225, and/or speaker 230 into a horizontal or vertical position. For example, the first portion 220, second portion 225, and speaker are positioned in a vertical manner by using the rotatable mechanism 235 to move rotate the first portion 220 and the second portion 225 clockwise. In an embodiment, the electronic device 205 represents a monoblock phone configuration for use during conversation. In an embodiment, a monoblock phone configuration may also be referred to as a candybar phone configuration. In an alternative embodiment, the electronic device 205 represents a QWERTY configuration for use of the keypad. It should be understood that in example embodiments the speaker 230 will be positioned in an advantageous location for a user. A technical effect of one or more of the example embodiments disclosed herein is use a rotatable mechanism to align an electronic device in a monoblock phone configuration.

In an example embodiment, the rotatable mechanism 235 comprises a navigation device 240. In an embodiment, the navigation device 240 is one or more buttons, graphic images, and/or the like configured to access features of the electronic device 205. For example, the navigation device 240 allows a user to initial a mobile communication, such as a phone call or text message.

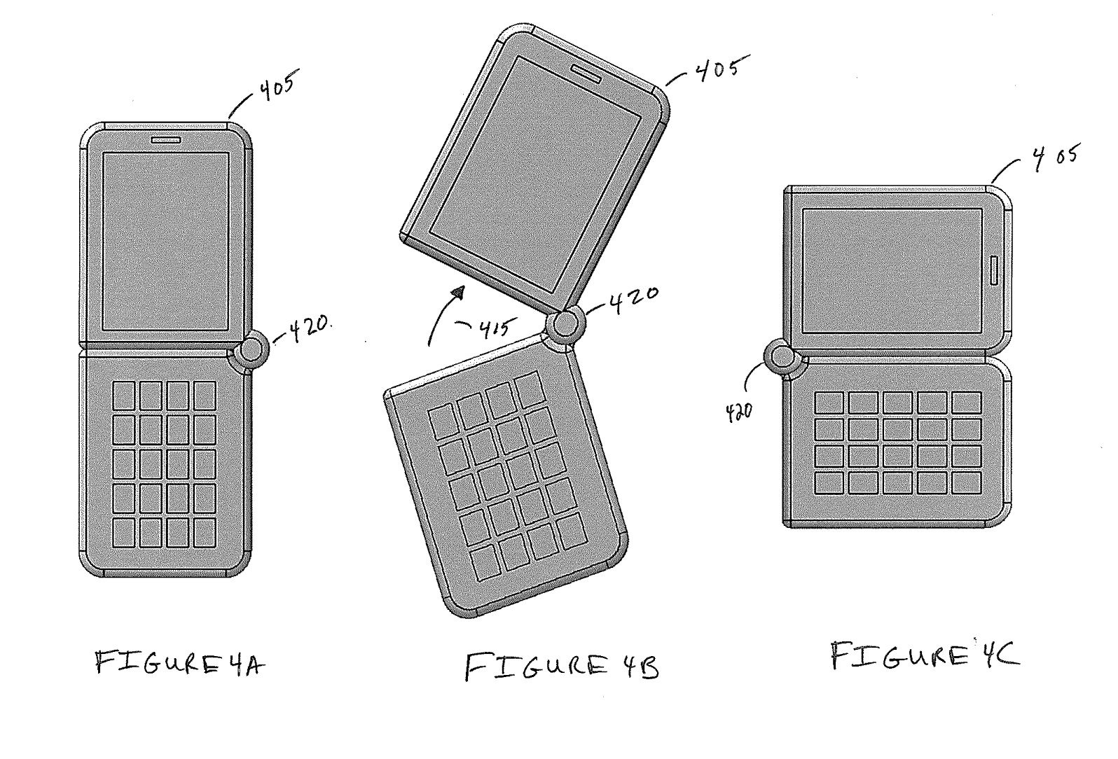

FIG. 3 is an exploded view of the electronic device of FIG. 2 operating in accordance with an example embodiment of the invention. In an example embodiment, the electronic device 205 comprises a first portion 320, a second portion 325, a rotatable mechanism 335, a speaker 330, a microphone 360, a grip 310, and/or the like.

In an example embodiment, the rotatable mechanism 335 is configured to rotatably move the first portion 320 and/or the second portion 325 to align the first portion 320, second portion 325, speaker 330, and/or microphone 360 in a horizontal or vertical position. For example, the second portion 325 rotatably moves over a pivot axis 305 in a clockwise direction 350 to align the first portion 320 and the second portion 325 in a horizontal orientation. It should be understood that in example embodiments the speaker 330 and/or microphone 360 may be positioned in an advantageous location for a user.

In an example embodiment, the rotatable mechanism 335 is a hinge. In an embodiment, the hinge may be made of flexible material, moving components, and/or the like. In an embodiment, a hinge is a type of bearing that connects the first portion 320 and the second portion 325. The connection allows an angular rotation between the first portion 320 and the second portion 325. In such a case, the first portion 320 and the second portion 325 rotate relative to each other about the pivot axis 305. In an embodiment, the pivot axis 305 is on the left side of the first portion 320 and the second portion 325. In an alternative embodiment, the pivot axis 305 may be on the right side of the first portion 320 and the second portion 325.

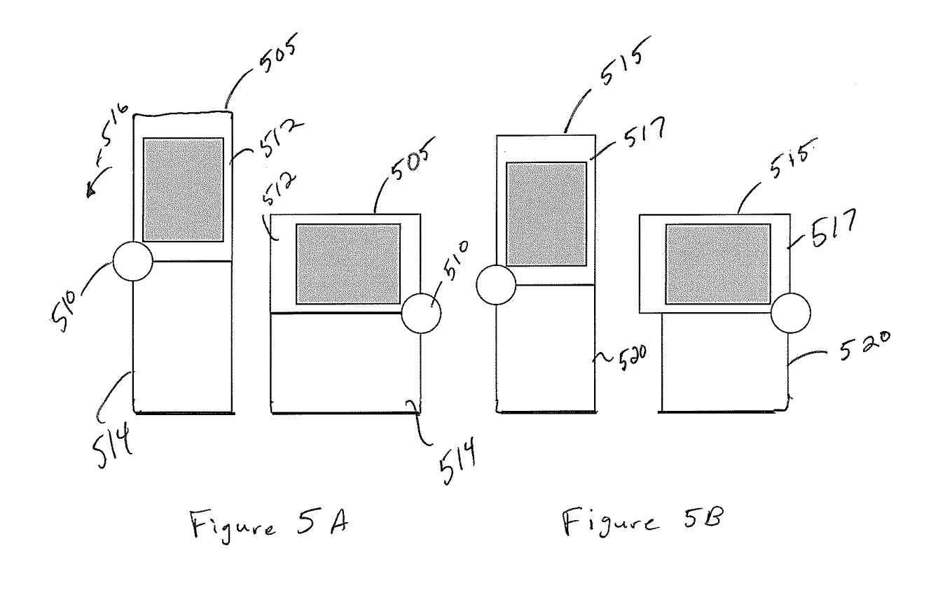

FIGS. 4A-C are block diagrams depicting the rotating of an electronic device 405 in accordance with an example embodiment of the invention. In an example embodiment, the electronic device 405 comprises a rotatable mechanism 420. In an example embodiment, the electronic device 405 is similar to electronic device 205 of FIG. 2 and the rotatable mechanism 420 is similar to the rotatable mechanism 235 of FIG. 2. In an alternative embodiment, the electronic device 405 is different than electronic device 205 of FIG. 2 and the rotatable mechanism 420 is different than rotatable mechanism 235 of FIG. 2.

Consider the following example. FIG. 4A depicts the electronic device 405 in a monoblock phone configuration. In this example, a user desires to change the electronic device 405 from a monoblock phone configuration to a QWERTY configuration using the rotatable mechanism 420. In such a case, the user rotates a portion of the electronic device 405, such as first portion 220 of FIG. 2, in a clockwise manner, over a pivot axis in the rotatable mechanism, using the rotatable mechanism as shown in FIG. 4B. In this case, the user aligns the first portion with another portion of the electronic device 405, such as second portion 225 of FIG. 2 using the pivot axis to apply a rotation resulting in a QWERTY configuration. FIG. 4C depicts the electronic device 405 in a QWERTY configuration. A technical effect of one or more of the example embodiments disclosed herein is use a rotatable mechanism to align an electronic device in a QWERTY configuration. It should be understood that the example embodiments of FIGS. 4A-C may employ a navigation device, such as navigation device 240 of FIG. 2.

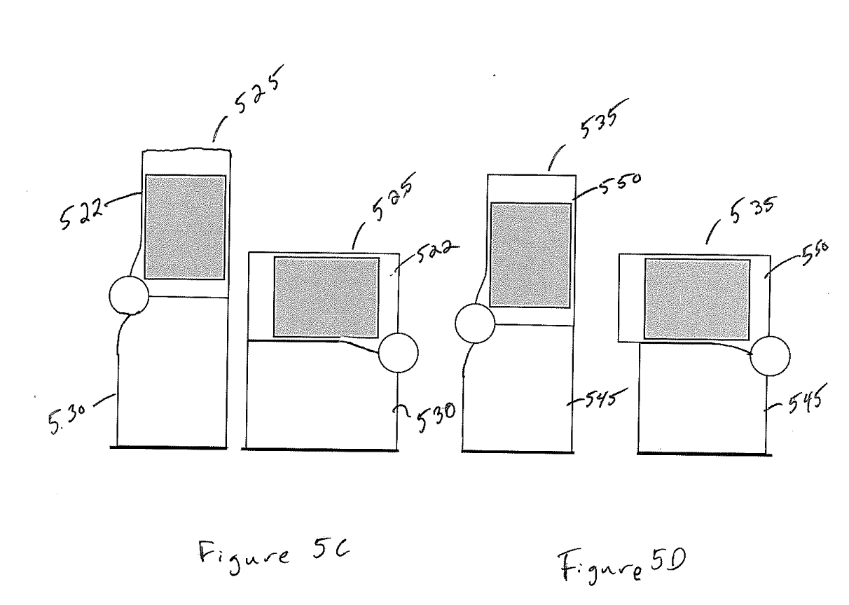

FIGS. 5A-D are block diagrams depicting rotatably aligned electronic devices 505, 515, 525, 535 in accordance with an example embodiment of the invention. In an example embodiment, electronic devices 505, 515, 525, 535 are similar to electronic device 205 of FIG. 2. In an alternative embodiment, electronic devices 505, 515, 525, 535 are different than electronic device 205 of FIG. 2.

FIG. 5A depicts an electronic device 505 in a monoblock phone configuration and a QWERTY configuration. The electronic device comprises a rotatable mechanism 510 on the left side. A user rotates a portion 512 in a counter-clockwise direction 516 to change from the monoblock phone configuration to the QWERTY configuration using the rotatable mechanism 510. In this example, the portion 512 is substantially the same size as another portion 514 of the electronic device 505. In an example embodiment, the monoblock phone configuration or the QWERTY configuration is more convenient, e.g., compact, for a user to store and/or transport.

FIG. 5B depicts an electronic device 515 in a monoblock phone configuration and a QWERTY configuration. In an embodiment, a first portion 517 comprises a display. In an embodiment, a second portion 520 comprises a keypad. In an example embodiment, a user rotates the first portion 517 in a counter-clockwise direction towards the second portion 520 using the rotatable mechanism. In such a case, the electronic device 515 is changed from a monoblock phone configuration to a QWERTY configuration. In an embodiment, the first portion 517 is wider than the second portion 520 in the QWERTY configuration. For example, the first portion 517 provides a user interface, which is larger than the second portion 520, e.g., display is larger than the keypad.

FIG. 5C depicts an electronic device 525 in a monoblock phone configuration and a QWERTY configuration. In an example embodiment, a user rotates a first portion 522 in a counter-clockwise direction towards a second portion 530 using the rotatable mechanism. In such a case, the electronic device 535 is changed from the monoblock phone configuration to the QWERTY configuration. In an embodiment, the first portion 522 is narrower than the second portion 530. For example, the first portion 522 provides a narrower view in the monoblock phone configuration.

FIG. 5D depicts an electronic device 535 in a monoblock phone configuration and a QWERTY configuration. In an example embodiment, a user rotates a first portion 550 in a counter-clockwise direction towards a second portion 545 using the rotatable mechanism. In such a case, the electronic device 535 is changed from the monoblock phone configuration to the QWERTY configuration. In an embodiment, the first portion 550 is wider than the second portion 545 and the second portion 545 is shorter than the first portion 550. For example, the electronic device 535 provides a wider user interface, e.g., display, and a shorter keypad.

It should be understood that a rotatable mechanism may be positioned on many different locations on an electronic device. Examples embodiments may be employed to change configurations using any of these different locations. It should be further understood that any number of configurations are possible by employing example embodiments. Further still, different size portions of the electronic device may be achieved in the monoblock phone configuration, QWERTY configuration, and/or the like.

Without in any way limiting the scope, interpretation, or application of the claims appearing below, it is possible that a technical effect of one or more of the example embodiments disclosed herein may be use a rotatable mechanism to align an electronic device in a qwerty configuration. Another technical effect of one or more of the example embodiments disclosed herein is use a rotatable mechanism to align an electronic device in a monoblock phone configuration.

Embodiments of the present invention may be implemented in software, hardware, application logic or a combination of software, hardware and application logic. The software, application logic and/or hardware may reside on an electronic device or a server. If desired, part of the software, application logic and/or hardware may reside on electronic device, and part of the software, application logic and/or hardware may reside on server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a first portion comprising a user interface;
a second portion comprising an input device; and
a rotatable mechanism configured to rotatably move the first portion and the second portion over a pivot axis to align the first portion and a second portion in a horizontal or vertical position.

2. The apparatus of claim 1 wherein the user interface is a display.

3. The apparatus of claim 1 wherein the first portion further comprises at least one of the following: a user interface or a speaker.

4. The apparatus of claim 1 wherein the second portion further comprises a grip.

5. The apparatus of claim 1 wherein the input device is a keypad.

6. The apparatus of claim 1 wherein the rotatable mechanism is a hinge.

7. The apparatus of claim 1 wherein the rotatable mechanism comprises a navigation device.

8. The apparatus of claim 1 wherein the pivot axis is on the left or right side of the first portion and the second portion.

9. The apparatus of claim 1 wherein the first portion and the second portion are different sizes.

10. The apparatus of claim 1 wherein the first portion and the second portion are substantially the same size.

11. A method, comprising:
rotatably moving a first portion and a second portion over a pivot axis to align the first portion and second portion in a horizontal or vertical position.

12. The method of claim 11 wherein the first portion comprises at least one of the following: a user interface or a speaker.

13. The method of claim 12 wherein the user interface is a display.

14. The method of claim 11 wherein the second portion comprises a grip.

15. The method of claim 11 wherein the second portion comprises an input device.

16. The method of claim 11 wherein rotatably moving a first and a second portion over a rotatable mechanism.

17. The method of claim 16 wherein the rotatable mechanism comprises a navigation device.

18. The method of claim 11 wherein the pivot axis is on the left or right side of the first portion and the second portion.

19. The method of claim 11 wherein the first portion and the second portion are different sizes.

20. The method of claim 11 wherein the first portion and the second portion are substantially the same size.

21-36. (canceled)
